(19) United States
(12) Patent Application Publication
(10) Pub. No.: US 2024/0018805 A1
(43) Pub. Date: Jan. 18, 2024

(54) INTERMODAL CONTAINER DOOR LOCK

(71) Applicant: David Johannes MAC DONALD, ALBERTON, GAUTENG (ZA)

(72) Inventor: David Johannes MAC DONALD, ALBERTON, GAUTENG (ZA)

(21) Appl. No.: 18/025,574

(22) PCT Filed: Aug. 17, 2021
(86) PCT No.: PCT/IB2021/057542

§ 371 Date: Mar. 9, 2023

(30) Foreign Application Priority Data
Aug. 17, 2020 (ZA) 2020/05063

(51) Int. Cl. E05B 83/08; E05B 81/06; E05B 81/16; E05B 81/30; E05C 9/04; B65D 88/12; B65D 90/00

(52) U.S. Cl. CPC E05B 83/08; E05B 81/06; E05B 81/16; E05B 81/30; E05C 9/041; B65D 88/121; B65D 90/008

(57) ABSTRACT

The invention provides a heavy-duty door lock (22) adapted for locking a door (10) of an intermodal container (12) comprising an internal lock member (24) arranged within the container (12) so as to lock a door (10) from with inside the container (12), the internal lock member (24) being displaceable between a locked and unlocked position; actuating means (26) arranged within the container (12) for displacing the internal lock member (24) between the locked and unlocked positions; and a locking mechanism (28) including an internal lock (52) which is located within the container (12) and which in a locked position prevents the actuating means (26) from displacing the internal lock member (24), and in an unlocked position allows the actuating means (26) to displace the internal lock member (24); and an external lock (54) which is located on the outside of a door (10) of the container (12) and which operatively displaces the internal lock (52) between the locked and unlocked positions.

### BACKGROUND TO THE INVENTION

An intermodal container is a large, standardized shipping container, which is designed and built for intermodal freight transport. These containers can be used across different modes of transport—from ship to rail to truck—without unloading io and reloading their cargo. Intermodal containers are primarily used to store and transport materials and products efficiently and securely. They are manufactured in a number of standardized sizes and are typically referred to as cargo or freight containers, ISO containers, shipping, sea or ocean containers, container vans, or container boxes. For purposes of this specification, the term “intermodal container” is used to designate all these various types of containers used across different modes of transport.

These intermodal containers are typically rectangular, closed box models, with steel doors fitted at one end of the container within a door frame and made of corrugated weathering steel. Each container typically includes two steel door leaves that are hingedly connected to rear corner posts of the container with drop forged steel hinge blades. Each door is fitted with vertically extending, elongate external lock rods which extend between the bottom and the top of the doors on the outside of the container, and which are used for opening, closing and locking of the doors. Each lock rod terminates at opposite ends thereof (i.e. top and bottom) in a cam, which is welded in place. Cam keepers are welded to a frame of the container and are configured such that the cams releasably engage the cam keepers. A door handle rotates the lock rods to initiate a door opening process by forcing the cams out of their keepers.

Intermodal containers are often the target of break-ins and burglary, and cargo theft results in millions of losses annually. The doors of such containers have always been the most vulnerable area for illegal entry into a cargo space. Several interlocking devices have been developed to protect the doors of trailers and/or containers against unauthorised opening. These include, for example, lock rod clamps and crossbar locks of heavy-duty steel tubing, that clamp over the lock rods and that prevent the primary doors' handles from turning. They are designed so that even if someone succeeds in cutting the padlock, they cannot turn the lock rods. Container bolts protect the doors of trailers and/or containers against forcible opening and may be placed around the door handles and locked sideways with an integrated lock cylinder.

The existing prior art solutions suffer from one or several disadvantages. The main disadvantage is that the existing interlocking devices that protect the doors against unauthorised opening generally engage the lock rods. However, perpetrators have become so sophisticated and well-equipped that they often use power tools to cut the lock rods above and below the locking device, effectively removing a portion of the lock rods and bypassing the locking device entirely. Another method used includes cutting the top and bottom cam of a lock rod, effectively disengaging the lock rod from the container. Another disadvantage is that some locking devices require modifications to the container itself, which is not only a cost factor, but also require skilled labour.

It is an object of the present invention to provide a heavy-duty cargo container door lock that is easily assembled as an add-on feature without requiring any modifications to the container or container doors, and that will improve theft prevention protocols of cargo through the container doors.

### SUMMARY OF THE INVENTION

According to the invention there is provided a heavy-duty door lock adapted for locking a door of an intermodal container, wherein the intermodal container includes an internal chamber which is defined by a container floor, a container roof and at least two sidewalls extending between the roof and the floor, and wherein the doors are hingedly mounted to one end of the container and locked by external lock rods; the door lock comprising
at least one elongate internal lock member arranged within the internal chamber so as to lock a door from with inside the chamber, the internal lock member being displaceable between a locked and unlocked position;
actuating means arranged within the internal chamber for displacing the internal lock member between the locked and unlocked positions; and
a locking mechanism including
   an internal lock which is located within the internal chamber and which in a locked position prevents the actuating means from displacing the internal lock member, and in an unlocked position allows the actuating means to displace the internal lock member; and
   an external lock which is located on the outside of a door of the container and which operatively displaces the internal lock between the locked and unlocked positions.

The door lock may comprise a set of at least two internal lock members with one internal lock member being operatively associated with a leading door of the container and with the other internal lock member being operatively associated with a follower door of the container, such that the leading door and the follower door are separately lockable to either one or both of the floor and/or roof of the container. The internal lock members may longitudinally be displaceable between the container floor and container roof between the locked and unlocked positions, such that in the locked position the internal lock members at least partially protrude into either one or both of the floor and/or the roof of the containers.

Each internal lock member may be spring-loaded. Particularly, the internal lock member may be spring-loaded to the locked position, such that the actuating means is required to move the internal lock member from the locked position into the unlocked position. More particularly, the internal lock member may be a slam-lock such that the doors of the container automatically lock when they close.

Each internal lock member may include at least one elongate lock rod, terminating at one end thereof in a spring-loaded head which is configured to engage either the roof or floor of the container. The spring-loaded head may comprise a latch connected to an end of the lock rod and including a latch body and a radially outwardly extending stopper flange; and a helical compression spring, coaxially arranged about the lock rod approximate the latch. The spring-loaded head may be housed within a housing which is connected to an inside of the container door, the housing including at one end thereof a latch aperture through which the latch protrudes into a locked position for locating in an aperture in either one of the container floor or roof; and including at an opposite end thereof a lock rod aperture to allow longitudinal displacement of the lock rod into and out of the housing to accommodate the spring action. The helical compression spring may be compressed during the unlocked position between the stopper flange of the latch and the housing. The elongate lock rod may be a flexible rod. Alternatively, the elongate lock rod may be flexible steel cable.

The actuating means may include a rack and pinion arrangement. More particularly, the actuating means may include at least one circular gear; and at least one linear gear which is operatively associated with the circular gear and connected to the internal lock member, the linear gear being longitudinally displaceable to move the internal lock member between the locked and unlocked positions. In a preferred embodiment of the invention the actuating means includes at least one circular gear, and two parallel linear gears arranged at radially opposite sides of the circular gear, with each linear gear being connected to an internal lock member. The linear gears may longitudinally be displaceable in opposite directions from each other such that one linear gear moves a first internal lock member into and out of engagement with the container roof, while the other linear gear moves a second internal lock member into and out of engagement with the container floor. When the actuating means is actuated against the spring-load, the rack and pinion arrangement moves the internal lock members from their locked positions engaged in the floor and roof of the container, to their unlocked positions disengaged from the floor and roof of the container.

The actuating means also may include a handle which is connected to the circular gear for rotating the same. A first handle may be connected to an outside of the leading door of the container and operatively associated with the circular gear of the leading door, while a second handle may be located to an inside of the follower door of the container and operatively associated with the circular gear of the follower door, to such that the follower door can only be opened from within the chamber after the leading door has been opened.

The locking mechanism may include a mechanical internal lock which is located within the internal chamber and which is displaceable between a locked and unlocked position; and an external lock which is located on the outside of the leading door of the container and which operatively displaces the internal lock on the leading door between the locked and unlocked positions. The internal lock may be a pivotable arm which is pivotable between a locked position, in which it engages the actuating means on the leading door to prevent displacement of at least one linear gear; and an unlocked position in which it is disengaged from the actuating means, allowing free displacement of the linear gear. The external lock may be a key-operated lock in which the key may be selected from a group including a mechanical key, a digital key, an NFC-enabled iOS or Android mobile phone key, a fob, a tag, or a PIN code. The external lock may be an iLOQ™.

In a second embodiment of the invention, the locking mechanism may include an electronic internal lock which is located within the internal chamber and which is displaceable between a locked and unlocked position; and an external electronic lock which is located on the outside of the leading door of the container and which operatively displaces the electronic internal lock on the leading door between the locked and unlocked positions.

The electronic internal lock may comprise a rotatable locking cam; an electric motor for rotating the locking cam; and an electronic receiver for actuating the motor. The io electronic internal lock may be displaceable between a locked position in which the locking cam engages at least one linear gear to prevent displacement of the linear gear; and an unlocked position in which the locking cam disengages the linear gear such that the linear gear is freely displaceable.

In this second embodiment of the invention, at least one linear gear includes an elongate gear extension extending substantially parallel to the lock rods. The gear extension provides a cam accommodating profile for capturing the locking cam when the electronic internal lock is in a locked position.

The locking cam comprises a flat base and a substantially U-shaped surface extending from the flat base; and is carried on a cam shaft which is connected to the electric motor, such that rotation of the cam shaft rotates the locking cam between a locked position, wherein the U-shaped surface of the locking cam is trapped within the cam accommodating profile of the gear extension, thus preventing displacement of the linear gear; and an unlocked position wherein the flat base of the locking cam is orientated towards the cam accommodating profile, thereby causing the locking cam to disengage from the cam accommodating profile of the gear extension, so as to enable displacement of the linear gear to open the locking mechanism.

### SPECIFIC EMBODIMENT OF THE INVENTION

Without limiting the scope thereof, the invention will now further be described and exemplified with reference to the following non-limiting examples and drawings, in which

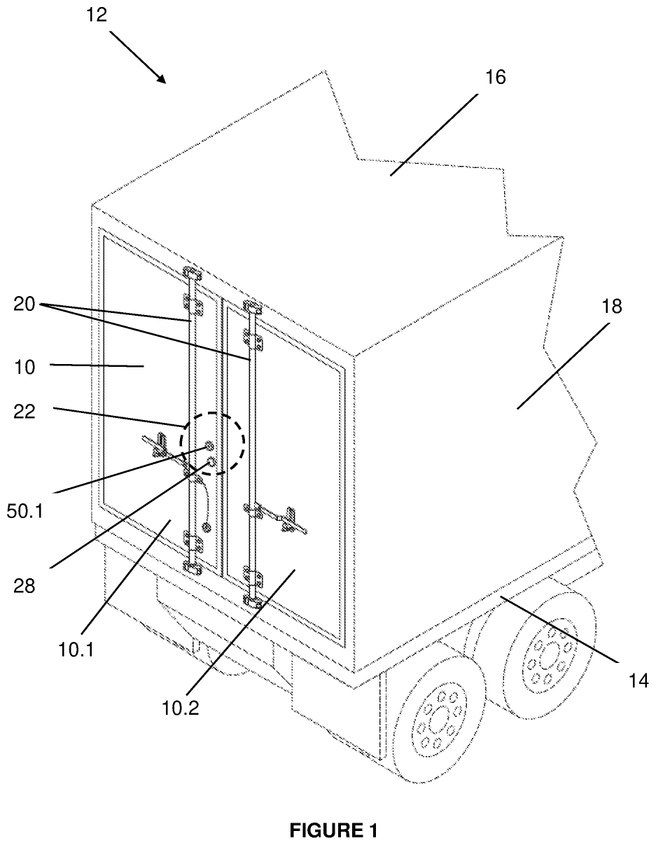

FIG. 1 is a rear view of an intermodal container, illustrating positioning of the door lock from an outside of the container;

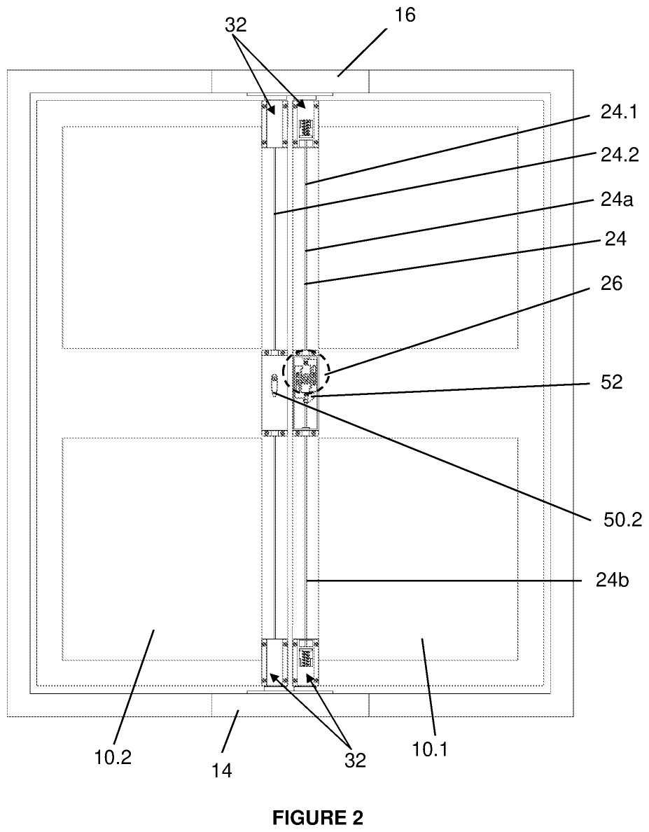

FIG. 2 is a view of the container doors of FIG. 1, looking at the container doors from with inside of the container chamber;

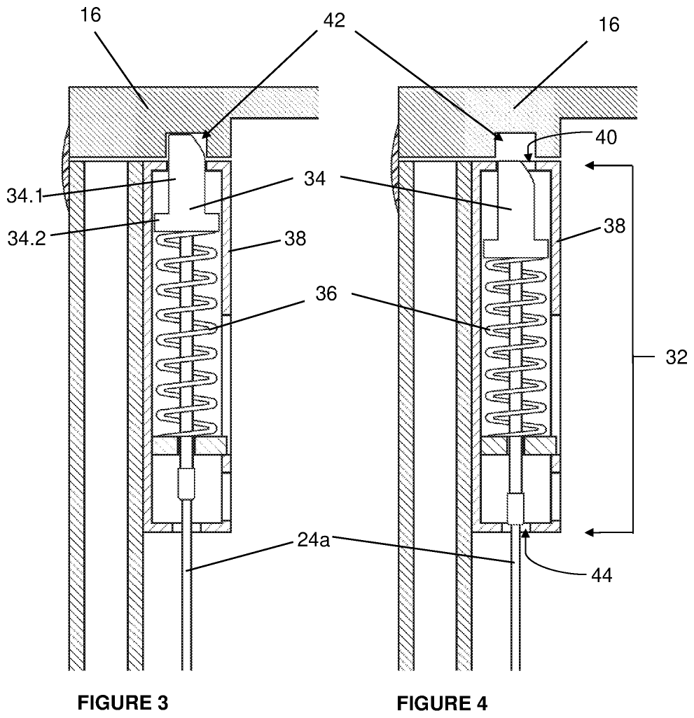

FIG. 3 is a sectioned side elevation of the spring-loaded head of the internal lock member of the invention, illustrating the latch and compression spring when the lock member is in a locked position;

FIG. 4 is a sectioned side elevation of the spring-loaded head of the internal lock member of the invention, illustrating the latch and compression spring when the lock member is in an unlocked position;

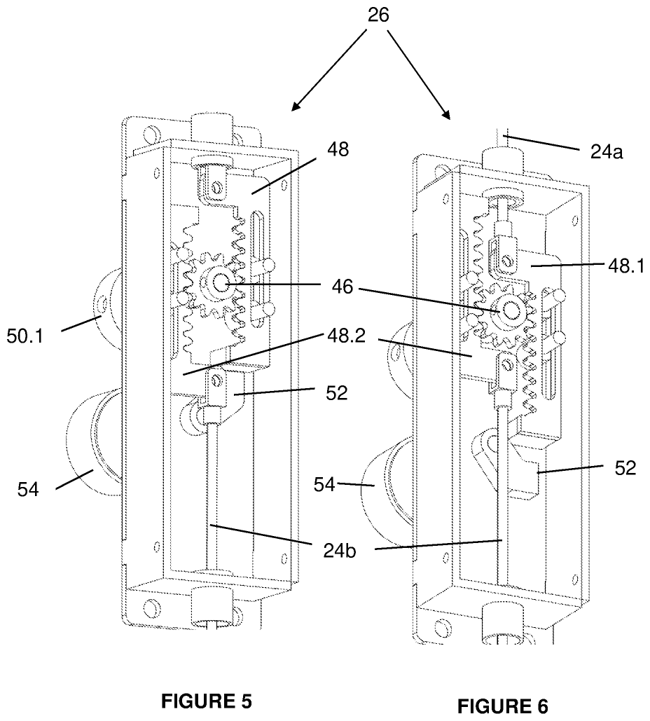

FIG. 5 is a perspective view of a first embodiment of the actuating means of the door lock of the invention, when the internal lock members are in a locked position;

FIG. 6 is a perspective view of the first embodiment of the actuating means of the door lock of the invention, when the internal lock members are in an unlocked position;

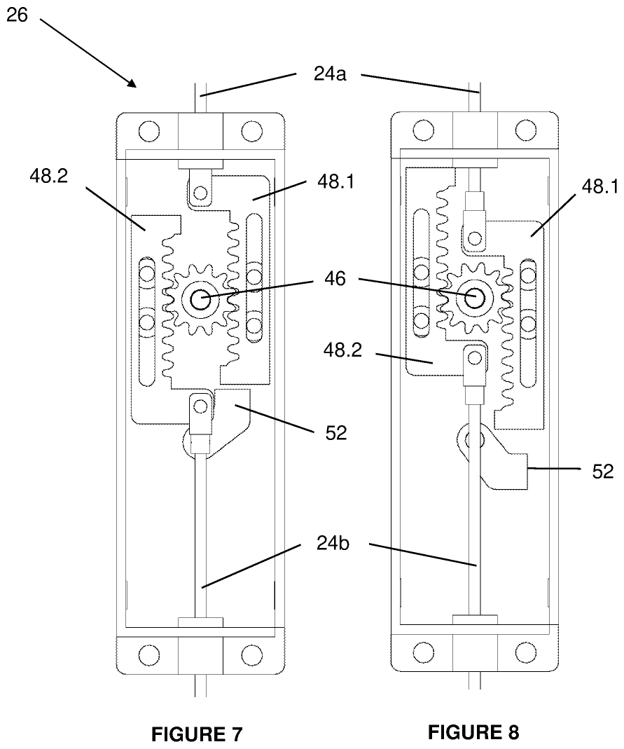

FIG. 7 is a front view of the actuating means of FIG. 5;

FIG. 8 is a front view of the actuating means of FIG. 6;

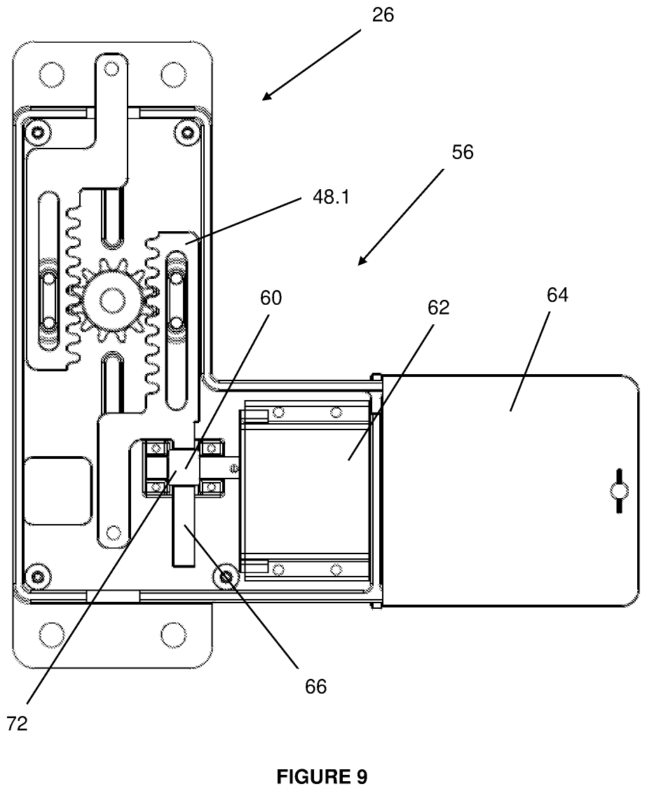

FIG. 9 is a front view of a second embodiment of the actuating means of the door lock of the invention;

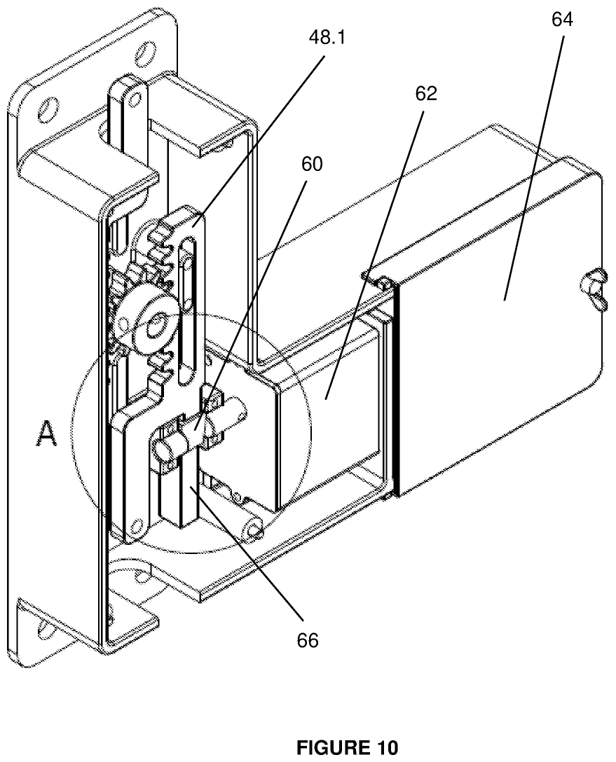

FIG. 10 is a perspective view of the second embodiment of the actuating means of FIG. 9 in a locked position;

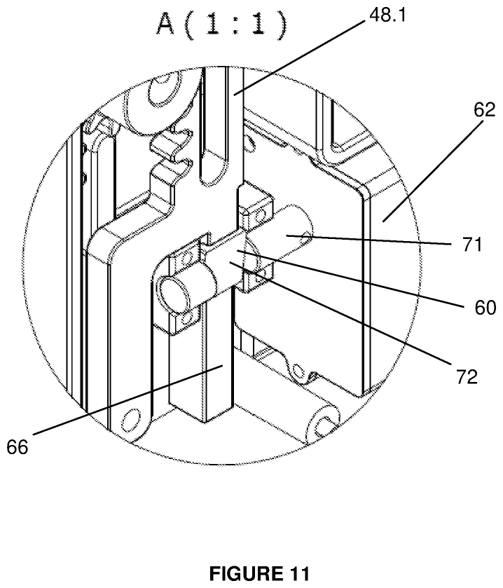

FIG. 11 is a detailed view of Section A of FIG. 10, illustrating an electronic locking mechanism in a locked position;

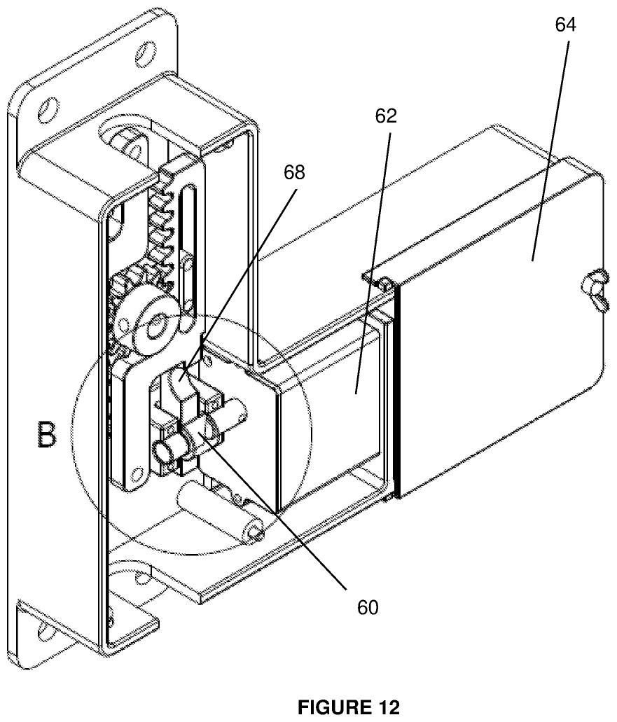

FIG. 12 is a perspective view of the second embodiment of the actuating means in an unlocked position; and

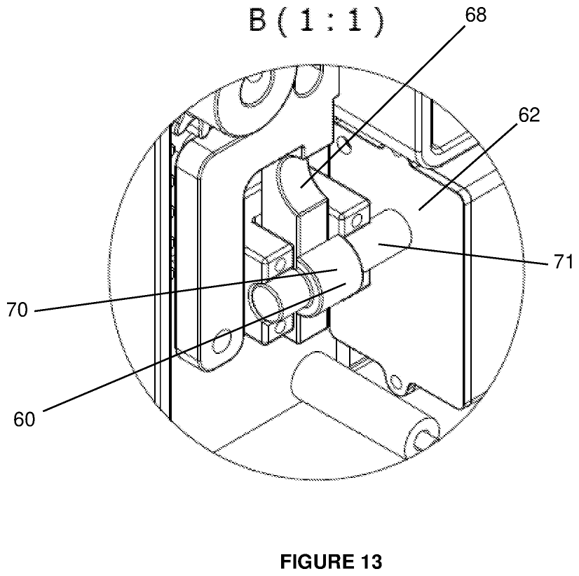

FIG. 13 is a detailed view of Section B of FIG. 12, illustrating the electronic locking mechanism in an unlocked position.

A door lock of the invention is adapted for locking a door of an intermodal container [12], wherein the intermodal container includes an internal chamber (not shown), which is defined by a container floor [14], a container roof [16], and at least two sidewalls extending between the roof and the floor [14]. The doors [10] are hingedly mounted to one end of the container and each door includes at least one, but typically a set of at least two, elongate external lock rods [20], extending vertically from a bottom end to a top end of the doors for locking the doors [10].

The door lock [22] comprises at least one elongate internal lock member which is arranged within the internal chamber so as to lock a door [10] from with inside the chamber. The internal lock member [24] is displaceable between a locked and an unlocked position. The door lock [22] also comprises actuating means [26] for displacing the internal lock member [24] between the locked and unlocked positions; and a locking mechanism [28] which in a locked position prevents the actuating means [26] from displacing the internal lock member [24], and in an unlocked position allows the actuating means [26] to displace the internal lock member [24].

In the illustrated embodiment, the door lock [22] comprises a set of two internal lock members [24.1; 24.2] with one internal lock member [24.1] being operatively associated with a leading door [10.1] of the container [12], and with the other internal lock member [24.2] being operatively associated with a follower door [10.2] of the container [12]. The leading door [10.1] and the follower door [10.2] are separately lockable to both the floor [14] and roof [16] of the container [12]. The internal lock members [24.1; 24.2] are longitudinally displaceable between the container floor [14] and container roof [16] between the locked and unlocked positions, such that in the locked position the internal lock members [24.1; 24.2] at least partially protrude into the floor [14] and roof [16] of the container [12].

Each internal lock member [24] is spring-loaded to the locked position, such that the actuating means [26] is required to move the internal lock member [24] from the locked position into the unlocked position. More particularly, the internal lock member [24] is a slam-lock such that the doors [10] of the container [12] automatically lock when they close.

Each internal lock member [24] includes two elongate lock rods [24a; 24b]. Each lock rod [24a; 24b] terminates at one end thereof in a spring-loaded head [32] which is configured to engage either the roof [16] or floor [14] of the container [12]. The spring-loaded head [32] comprises a latch [34] which is connected to an end of the lock rod [24a; 24b] and includes a latch body [34.1] and a radially outwardly extending stopper flange [34.2]. The head [32] also includes a helical compression spring [36], which is coaxially arranged about the lock rod [24a; 24b] approximate the latch [34].

The spring-loaded head [32] is housed within a housing [38] which is connected to an inside of the container door [10]. The housing [38] includes at one end thereof a latch aperture [40] through which the latch body [34.1] protrudes into a locked position for locating in an aperture [42] in either the container floor [14] or roof [16]. The housing [38] includes at an opposite end thereof a lock rod aperture [44] to allow longitudinal displacement of the lock rod [24a; 24b] into and out of the housing [38] to accommodate the spring action. The helical compression spring [36] is compressed during the unlocked position between the stopper flange [34.2] of the latch [34] and the housing [38].

The actuating means [26] includes a rack and pinion arrangement [48; 46]. More particularly, the actuating means [26] includes at least one circular gear [46]; and at least one linear gear [48] which is operatively associated with the circular gear and connected to the internal lock member [24]. The linear gear [48] is longitudinally displaceable to move the internal lock member [24] between the locked and unlocked positions. In the illustrated embodiment of the invention the actuating means includes the circular gear [46], and two parallel linear gears [48.1; 48.2] which are arranged at radially opposite sides of the circular gear [46], with each linear gear [48] being connected to one of the elongate lock rods [24a; 24b]. The linear gears [48] are longitudinally displaceable in opposite directions to each other such that one linear gear [48.1] moves a first internal elongate lock rod [24a] into and out of engagement with the container roof [16], while the other linear gear [48.2] moves a second elongate lock rod [24b] into and out of engagement with the container floor [18]. When the actuating means [26] is actuated against the spring-load, the rack to and pinion arrangement [48; 46] moves the internal elongate lock rods [24a, 24b] from their locked positions engaged in the floor [140] and roof [16] of the container [12], to their unlocked positions disengaged from the floor [14] and roof [16] of the container [12].

The actuating means [26] also includes a handle [50.1; 50.2] which is connected to the circular gear [46] for rotating the same. A first handle [50.1] is connected to an outside of the leading door [10.1] of the container [12] and operatively associated with the circular gear [46] of the leading door [10.1], while a second handle [50.2] (FIG. 2) is located to an inside of the follower door [10.2] of the container [12] and is operatively associated with the circular gear [46] of the follower door [10.2]. This arrangement means that the follower door [10.2] can only opened from within the chamber after the leading door [10.1] has been opened.

In a first embodiment of the invention (FIGS. 5-8) the locking mechanism [28] includes a mechanical internal lock [52] which is located within the internal chamber and which is displaceable between a locked and unlocked position; and an external lock [54] which is located on the outside of the leading door [10.1] of the container [12] and which operatively displaces the internal lock [52] on the leading door [10.1] between the locked and unlocked positions. The internal lock [52] is a pivotable arm which is pivotable between a locked position, in which it engages at least one linear gear [48.1] of the actuating means [26] on the leading door [10.1] to prevent displacement of that linear gear [48.1]; and an unlocked position in which it is disengaged from the actuating means [26], allowing free displacement of the linear gear [48.1].

The external lock [54] is a key-operated lock in which the key is selected from a group including a mechanical key, a digital key, an NFC-enabled iOS or Android mobile phone key, a fob, a tag, or a PIN code. The external lock [54] may be an iLOQ™.

In use, the external lock [54] is opened with the key, which displaces the internal lock [52] to the unlocked position, allowing free displacement of the linear gear [48.1]. Handle [50.1] is turned which turns circular gear [46], which in turn longitudinally moves linear gear [48.1] such that it displaces the first internal lock rod [24a] out of engagement with the container roof [16], while the other linear gear [48.2] is moved longitudinally to displace the second internal lock rod [24b] out of engagement with the container floor [18]. The leading door [10.1] can now be opened. Handle [50.2] is then manually turned from inside of the container chamber, which moves the internal lock member [24.2] out of engagement with the container floor [14] and roof [16]. The follower door [10.2] can now be opened.

In a second embodiment of the invention (illustrated in FIGS. 9-13), the locking mechanism [28] includes an electronic internal lock [56] which is located within the internal chamber and which is displaceable between a locked and unlocked position; and an external electronic lock (not shown) which is located on the outside of the leading door [10.1] of the container [12] and which operatively displaces the electronic internal lock [56] on the leading door [10.1] between the locked and unlocked positions.

to The electronic internal lock [56] comprises a rotatable locking cam [60]; an electric motor [62] for rotating the locking cam; and an electronic receiver [64] for actuating the motor [62]. The electronic internal lock [56] is displaceable between a locked position in which the locking cam [60] engages the linear gear [48.1] to prevent displacement of the linear gear [48.1]; and an unlocked position in which the locking cam disengages the linear gear [48.1] such that the linear gear [48.1] is freely displaceable.

In this second embodiment of the invention, at least one linear gear [48.1] includes an elongate gear extension extending [66] substantially parallel to the lock rods [24a; 24b]. The gear extension [66] provides a cam accommodating profile [68] for capturing the locking cam [60] when the electronic internal lock [56] is in a locked position.

The locking cam [60] comprises a flat base [72] and a substantially U-shaped surface [70] extending from the flat base [72]. The locking cam [60] is carried on a cam shaft [71] which is connected to the electric motor [62] and which rotates the locking cam [60] between a locked position, as shown in FIGS. 9 to 11, wherein the U-shaped surface [70] of the locking cam [60] is located in the cam accommodating profile [68] of the gear extension [66]; and an unlocked position, as shown in FIGS. 12 and 13, wherein a flat surface [72] of the locking cam [60] is orientated towards the cam accommodating profile [68], thereby causing the locking cam [60] to disengage from the cam accommodating profile [68] of the gear extension [66].

Once the locking cam has been disengaged from the gear extension [66], the linear gear [48.1] is free to be displaced to allow the actuating means [26] to be actuated. Once the actuating means [26] returns to its spring-loaded position, the locking cam [60] is rotated such that the circular-shaped surface [70] of the locking cam [60] is once again trapped within the cam accommodating profile [68] of the extension [66].

The electric motor [62], which actuates the cam [60] between the engaged and disengaged positions, receives electronic communication from the receiver [64]. The receiver [64] is connected to the external lock [54] and receives an electronic command from a transmitter (not shown) to signal the motor [62] to actuate the cam [60] between the engaged and disengaged positions. The receiver [64] is connected to the motor [62] via electric cables (not shown). The receiver [64] may be selected from a group of receivers capable of receiving electronic signals from a digital key, an NFC-enabled iOS or Android mobile phone key, a fob, a tag or a PIN code.

It will be appreciated that other embodiments of the invention are possible without departing from the spirit or scope of the invention as defined in the claims.

1. A heavy-duty door lock adapted for locking a door of an intermodal container, wherein the intermodal container includes an internal chamber which is defined by a container floor, a container roof and at least two sidewalls extending between the roof and the floor, and wherein the doors are hingedly mounted to one end of the container and locked by external lock rods; the door lock comprising
at least one elongate internal lock member arranged within the internal chamber so as to lock a door from with inside the chamber, the internal lock member being displaceable between a locked and unlocked position;
actuating means arranged within the internal chamber for displacing the internal lock member between the locked and unlocked positions; and
a locking mechanism including
an internal lock which is located within the internal chamber and which in a locked position prevents the actuating means from displacing the internal lock member, and in an unlocked position allows the actuating means to displace the internal lock member; and
an external lock which is located on the outside of a door of the container and which operatively displaces the internal lock between the locked and unlocked positions.

2. The door lock according to claim 1 wherein the door lock comprises a set of at least two internal lock members with one internal lock member being operatively associated with a leading door of the container and with the other internal lock member being operatively associated with a follower door of the container, such that the leading door and the follower door are separately lockable to either one or both of the floor and/or roof of the container.

3. The door lock according to claim 2, wherein the internal lock members are longitudinally displaceable between the container floor and container roof between the locked and unlocked positions, such that in the locked position the internal lock members at least partially protrude into either one or both of the floor and/or the roof of the container.

4. The door lock according to claim 3, wherein each internal lock member may be spring-loaded.

5. The door lock according to claim 4, wherein the internal lock member is spring-loaded to the locked position, such that the actuating means is required to move the internal lock member from the locked position into the unlocked position.

6. The door lock according to claim 5, wherein the internal lock member is a slam-lock such that the doors of the container automatically lock when they close.

7. The door lock according to claim 1, wherein each internal lock member comprises two elongate lock rods, with each lock rod terminating at one end thereof in a spring-loaded head which is configured to engage either the roof or floor of the container.

8. The door lock according to claim 7, wherein the spring-loaded head comprises a latch connected to an end of the lock rod and including a latch body and a radially outwardly extending stopper flange; and a helical compression spring, coaxially arranged about the lock rod approximate the latch.

9. The door lock according to claim 8, wherein the spring-loaded head is housed within a housing which is connected to an inside of the container door, the housing including at one end thereof a latch aperture through which the latch protrudes into a locked position for locating in an aperture in either one of the container floor or roof; and including at an opposite end thereof a lock rod aperture to allow longitudinal displacement of the lock rod into and out of the housing to accommodate the spring action.

10. The door lock according to claim 8, wherein the helical compression spring is compressed during the unlocked position between the stopper flange of the latch and the housing.

11. The door lock according to claim 7, wherein the elongate lock rod is a flexible rod, preferably a flexible steel cable.

12. The door lock according to claim 1, wherein the actuating means includes a rack and pinion arrangement.

13. The door lock according to claim 12, wherein the actuating means includes at least one circular gear; and at least one linear gear which is operatively associated with the circular gear and connected to the internal lock member, the linear gear being longitudinally displaceable to move the internal lock member between the locked and unlocked positions.

14. The door lock according to claim 13, wherein the actuating means includes at least one circular gear, and two parallel linear gears arranged at radially opposite sides of the circular gear, with each linear gear being connected to one of the lock rods.

15. The door lock according to claim 14, wherein the linear gears are longitudinally displaceable in opposite directions to each other such that one linear gear moves a first lock rod into and out of engagement with the container roof, while the other linear gear moves a second lock rod into and out of engagement with the container floor such that when the actuating means his actuated against the spring-load, the rack and pinion arrangement moves the internal lock rods from their locked positions, where they are engaged in the floor and roof of the container, to their unlocked positions, where they are disengaged from the floor and roof of the container.

16. The door lock according to claim 13, wherein the actuating means also includes a handle which is connected to the circular gear for rotating the same.

17. The door lock according to claim 16, wherein a first handle is connected to an outside of the leading door of the container and operatively associated with the circular gear of the leading door, while a second handle is located to an inside of the follower door of the container and operatively associated with the circular gear of the follower door, such that the follower door can only be opened from within the chamber after the leading door has been opened.

18. The door lock according to claim 13, wherein the locking mechanism includes a mechanical internal lock which is located within the internal chamber and which is displaceable between a locked and unlocked position; and an external lock which is located on the outside of the leading door of the container and which operatively displaces the internal lock on the leading door between the locked and unlocked positions.

19. The door lock according to claim 18, wherein the internal lock is a pivotable arm which is pivotable between a locked position, in which it engages the actuating means on the leading door to prevent displacement of at least one linear gear; and an unlocked position in which it is disengaged from the actuating means, allowing free displacement of the linear gear.

20. The door lock according to claim 19, wherein the external lock is a key-operated lock in which the key is selected from a group including a mechanical key, a digital key, an NFC-enabled iOS or Android mobile phone key, a fob, a tag, or a PIN code.

21. The door lock according to claim 20, wherein the external lock is an iLOQ™.

22. The door lock according to claim 13, wherein the locking mechanism includes an electronic internal lock which is located within the internal chamber and which is displaceable between a locked and unlocked position; and
an external electronic lock which is located on the outside of the leading door of the container and which operatively displaces the electronic internal lock on the leading door between the locked and unlocked positions.

23. The door lock according to claim 22, wherein the electronic internal lock comprises a rotatable locking cam; an electric motor for rotating the locking cam; and an electronic receiver for actuating the motor, the electronic internal lock being displaceable between a locked position in which the locking cam engages the linear gear to prevent displacement of the linear gear; and an unlocked position in which the locking cam disengages the linear gear such that the linear gear is freely displaceable.

24. The door lock according to claim 23, wherein at least one linear gear includes an elongate gear extension extending substantially parallel to the lock rods; the gear extension providing a cam accommodating profile for capturing the locking cam when the electronic internal lock is in a locked position.

25. The door lock according to claim 24, wherein the locking cam comprises a flat base and a substantially U-shaped surface extending from the flat base, and wherein the locking cam is carried on a cam shaft which is connected to the electric motor which rotates the locking cam between a locked position, wherein the U-shaped surface POI-of the locking cam is located in the cam accommodating profile of the gear extension; and an unlocked position, wherein the flat surface of the locking cam is orientated towards the cam accommodating profile, thereby causing the locking cam to disengage from the cam accommodating profile of the gear extension, such that the linear gear is free to be displaced to allow the actuating means to be actuated.

26. The door lock according to claim 25, wherein the electric motor which actuates the cam between the engaged and disengaged positions, receives electronic communication from the receiver, which in turn is connected to the external lock and receives an electronic command from a transmitter to signal the motor to actuate the cam between the engaged and disengaged positions.

27. The door lock according to claim 26, wherein the receiver is selected from a group of receivers capable of receiving electronic signals from a digital key, an NFC-enabled iOS or Android mobile phone key, a fob, a tag or a PIN code.

28. The door lock according to claim 1 substantially as herein illustrated and exemplified with reference to the accompanying drawings.
